(19) United States
(12) Patent Application Publication
(10) Pub. No.: US 2008/0300837 A1
(43) Pub. Date: Dec. 4, 2008

(54) Methods, Computer Program Products and Apparatus Providing Improved Selection of Agreements Between Entities

(76) Inventors: Melissa Jane Buco, Amawalk, NY (US); Genady Grabarnik, Scarsdale, NY (US); Larisa Shwartz, Scarsdale, NY (US); Maheswaran Surendra, Croton-on-Hudson, NY (US); Christopher Ward, Glen Ridge, NJ (US)

Correspondence Address: Harrington & Smith, LLP, 4 Research Drive, Shelton, CT, 06484-6212, US

(21) Appl. No.: 11/755,911

(22) Filed: May 31, 2007

(51) Int. Cl. G06G 7/48

(52) U.S. Cl. 703/6

(57) ABSTRACT

The exemplary embodiments of the invention provide methods, computer program products and apparatus that describe techniques for improved selection of agreements between entities, such as between a service provider and another entity (e.g., a supplier or customer of the service provider). In one non-limiting, exemplary embodiment, a method includes: providing a workflow model for a plurality of sub-processes, wherein the plurality of sub-processes has a plurality of second values, wherein each sub-process of the plurality of sub-processes has a different second value of the plurality of second values corresponding to a property common to each sub-process of the plurality of sub-processes, wherein the workflow model is a workflow model of a process; determining a first probability distribution of a first value for the process based on a plurality of second probability distributions for the plurality of second values, wherein each second probability distribution of the plurality of second probability distributions is for a different second value of the plurality of second values; and selecting an agreement based on the determined first probability distribution of the first value, wherein the selected agreement is an agreement to be used between a first entity and a second entity.

### TECHNICAL FIELD

The exemplary embodiments of this invention relate generally to agreements between business entities and, more specifically, relate to the selection of such agreements.

### BACKGROUND

Outsourcing of information technology (IT) services emerged as a way for non-IT organizations to increase efficiency, increase capacity and mitigate risks associated with supporting an IT environment. Many businesses utilize outsourced IT services to meet their business requirements. These business requirements may be static or dynamic. IT service providers generally face an increasingly competitive landscape in addition to growing government and industry requirements. In pursuit of their goal of maximizing customer satisfaction, service providers generally seek to employ intelligent business solutions which provide deep analysis and orchestration of business processes and capabilities for optimizing the level of service and cost.

The global information society is an open service customer-driven market. User perspective influences functionality, design, and management of services. Information Technology Infrastructure Library (ITIL®) best practices and ISO 20000 are representations of this new approach. Traditional technology-centric methodology for defining services is often being replaced by services defined by what they provide to the users.

As the structure of the IT outsourcing industry moves towards a global service-driven market, the role of service providers is undergoing noticeable change. Service providers are generally no longer willing to build and use services for a single customer or internal business unit but instead are looking to utilize single service management solutions using shared resources for a wide range of customers and services. The fact that resources may have different owners and users should be taken into account. Therefore, multi-customer issues may play a critical role in this environment.

There is increasing competition among service providers to offer new and customized services and provide customers with management functionality that enables customers to monitor, control and optimize these services. Thus, IT service providers generally strive to introduce more sophisticated and automated procedures into service management in order to meet customer demands and remain competitive.

### SUMMARY

In an exemplary aspect of the invention, a method includes: providing a workflow model for a plurality of sub-processes, wherein the plurality of sub-processes has a plurality of second values, wherein each sub-process of the plurality of sub-processes has a different second value of the plurality of second values corresponding to a property common to each sub-process of the plurality of sub-processes, wherein the workflow model is a workflow model of a process; determining a first probability distribution of a first value for the process based on a plurality of second probability distributions for the plurality of second values, wherein each second probability distribution of the plurality of second probability distributions is for a different second value of the plurality of second values; and selecting an agreement based on the determined first probability distribution of the first value, wherein the selected agreement is an agreement to be used between a first entity and a second entity.

In another exemplary aspect of the invention, a computer program product includes program instructions embodied on a tangible computer-readable medium. Execution of the program instructions results in operations including: providing a workflow model for a plurality of sub-processes, wherein the plurality of sub-processes has a plurality of second values, wherein each sub-process of the plurality of sub-processes has a different second value of the plurality of second values corresponding to a property common to each sub-process of the plurality of sub-processes, wherein the workflow model is a workflow model of a process; determining a first probability distribution of a first value for the process based on a plurality of second probability distributions for the plurality of second values, wherein each second probability distribution of the plurality of second probability distributions is for a different second value of the plurality of second values; and selecting an agreement based on the determined first probability distribution of the first value, wherein the selected agreement is an agreement to be used between a first entity and a second entity.

In a further exemplary aspect of the invention, a processing device includes: an input configured to receive a workflow model for a plurality of sub-processes, wherein the plurality of sub-processes has a plurality of second values, wherein each sub-process of the plurality of sub-processes has a different second value of the plurality of second values corresponding to a property common to each sub-process of the plurality of sub-processes, wherein the workflow model is a workflow model of a process; a processing unit coupled to the input and configured to determine a first probability distribution of a first value for the process based on a plurality of second probability distributions for the plurality of second values and to select an agreement based on the determined first probability distribution of the first value, wherein each second probability distribution of the plurality of second probability distributions is for a different second value of the plurality of second values, wherein the selected agreement is an agreement to be used between a first entity and a second entity; and an output coupled to the processing unit and configured to output an identification of the selected agreement.

In another exemplary aspect of the invention, a method includes: obtaining a plurality of sub-processes involved in a process, wherein the plurality of sub-processes comprises a plurality of second values, wherein each sub-process of the plurality of sub-processes has a different second value of the plurality of second values corresponding to a property common to each sub-process of the plurality of sub-processes; obtaining a workflow topology of the process; obtaining a plurality of second probability distributions for the plurality of second values, wherein each second probability distribution of the plurality of second probability distributions is for a different second value of the plurality of second values; determining a first probability distribution of a first value for the process based on the plurality of second probability distributions for the plurality of second values; and selecting an agreement based on the determined first probability distribution of the first value, wherein the selected agreement is an agreement to be used between a first entity and a second entity.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 depicts a flowchart illustrating one non-limiting example of a method for practicing the exemplary embodiments of this invention;

FIG. 2 depicts an exemplary model of two consecutive tasks;

FIG. 3 illustrates an exemplary model of three tasks;

FIG. 4 depicts another exemplary model of three tasks;

FIG. 5 illustrates another exemplary model of three tasks;

FIG. 6 shows an exemplary model of four tasks;

FIG. 7 shows a graph of an exemplary downtime function for a task;

FIG. 8 shows a graph of an exemplary service level agreement (SLA) function (SLi) for a task Ti mapping downtime of the task Ti to the associated loss L;

FIG. 9 depicts a flowchart illustrating one non-limiting example of a method for evaluating the effectiveness of SLAs;

FIG. 10 shows a macro-level organizational model of the entities, interactions and agreements in an exemplary business arrangement; and

FIG. 11 illustrates a simplified block diagram of an electronic device that is suitable for use in practicing the exemplary embodiments of this invention.

### DETAILED DESCRIPTION

The following terms, as utilized herein, are defined as follows.

The term “entity” refers to an individual, group, organization, business or company. Depending on the context of usage, the term may also refer to other units, such as a department or other internal organizational unit of a company (e.g., a service provider), as a non-limiting example.

An IT service provider or “service provider” is an entity that is responsible for the provisioning of services (e.g., IT services) to one or more other entities. In ISO 20000 terminology, such service providers may be referred to as “external service providers.”

The term “customer” refers to an entity that buys services which are either used by the entity (e.g., users in the organization) or by customers of the entity. Note that according to this definition, a service provider organization can itself be a customer. Generally, the customer defines the service requirements.

A “supplier” is an entity that provides various services or products to one or more other entities. What distinguishes a supplier from a service provider is that a supplier usually provides basic (or atomic) service(s) and generally does not control the infrastructure.

Participants in IT service management are referred to as “stakeholders.”

An “agreement” is considered to be a contract (e.g., formal or informal, written or oral) between two or more entities that provides guidance regarding the interaction(s) (e.g., providing of services or products) between the respective entities.

As a non-limiting example, a service level agreement (SLA) is an agreement that exists between a service provider and one or more other entities (e.g., a supplier or a customer). SLAs commonly include segments to address: a definition of services, performance measurement, problem management, customer duties, warranties, disaster recovery and termination of the agreement, as non-limiting examples. While exemplary embodiments of the invention may be discussed below in terms of one or more SLAs, it should be appreciated that an SLA is only one example of the types of agreements with which the exemplary embodiments of the invention may be utilized.

As another non-limiting example, an operational level agreement (OLA) is an internal agreement that exists between elements or entities (e.g., departments) of a larger entity. For example, two departments or sections of a service provider may have an OLA between them that covers the delivery of products or services within the service provider.

A “value” is defined as a magnitude or quantity. As non-limiting examples, a value may comprise: a scalar (e.g., a number), a vector, a tensor, a function or an n-dimensional expression. As non-limiting examples, a value may be static and/or dynamic. As further non-limiting examples, a value may be a real number or a complex number.

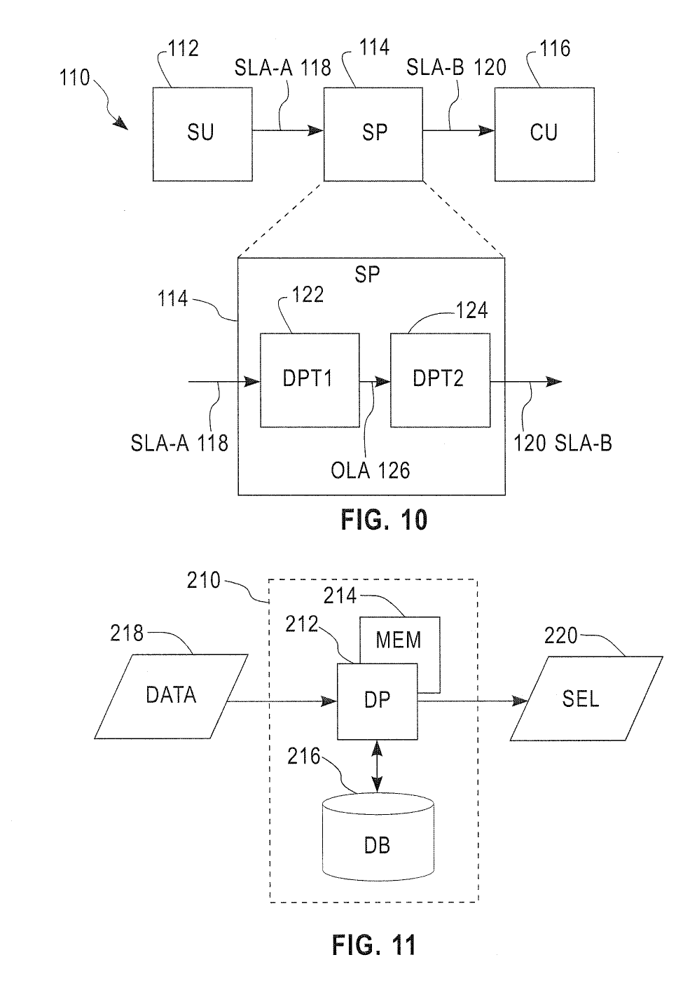

FIG. 10 shows a macro-level organizational model 110 of the entities, interactions and agreements in an exemplary business arrangement. The model 110 includes a supplier (SU) 112, a service provider (SP) 114 and a customer (CU) 116. The SU 112 provides products and/or services to the SP 114. The SP 114 provides services (e.g., IT services) to the CU 116. The interactions between the SU 112 and the SP 114 are governed by a first service level agreement (SLA-A) 118. As a non-limiting example, the SLA-A 118 may describe the products and/or services to be provided to the SP 114 by the SU 112. The interactions between the SP 114 and the CU 116 are governed by a second service level agreement (SLA-B) 120. As a non-limiting example, the SLA-B 120 may describe the products and/or services to be provided to the CU 116 by the SP 114.

In further exemplary embodiments, and as shown in FIG. 10, the SP 114 may itself comprise a plurality of entities, such as a first department (DPT1) 122 and a second department (DPT2) 124. The interactions between DPT1 122 and DPT2 124 are governed by an operational level agreement (OLA) 126. As a non-limiting example, the OLA 126 may describe the support (e.g., services, products, timelines) required in order for the SP 114 to provide the services that are described by the SLA-B 120.

Generally, for management of IT services, an SLA is a conventional method of regulating a service provider's contractual obligations. The collaboration among the various stakeholders of the delivery and management of IT services is an integral part of IT Service Management and may be thoroughly analyzed. To date, attention has been directed primarily to the technology for service delivery rather than issues concerning collaboration.

A customer's infrastructure may span many locations and sites (e.g., it may be globally distributed). Technological changes and business trends have resulted in customers and users playing a significant role in service delivery. Corporate customers, for whom responsive and efficient IT services may be critical to their core business, are becoming more knowledgeable on the services that their company has outsourced. Customers may have real-time requirements and demand reliability and robustness. In turn, IT service providers may be called upon to provide such reliable and robust services in order to support and retain their clients' business.

In light of the above, it is generally preferable to use a suitable agreement (e.g., SLA) for each of the various interactions. Specifically, for a given complex service process description, the process may be partitioned into sub-processes that may be performed by different parties and regulated by different agreements (e.g., SLAs) that define the contractual commitments of these parties. For example, generally it may be desirable: to determine whether an agreement between a service provider and one or more customers will be efficient in comparison with an agreement between the service provider and its suppliers (e.g., internal or external suppliers); and to determine which supplier is the most appropriate in order to satisfy a given agreement with a customer.

One prior art solution is to use an agreement (e.g., SLA) and subsequently change it (e.g., modify its terms or conditions) if the agreement becomes unsuitable or contains undesirable elements or clauses. However, this approach may be unsuitable in various circumstances.

Reference with regard to a multi-tier SLA method and system may be made to commonly-assigned U.S. Pat. No. 7,099,936 to Chase et al. Reference with regard to a design rationale of a business-objectives-based utility computing SLA management system (SAM) and implementation experiences relating thereto may be made to Buco et al., “Utility computing SLA management based upon business objectives,” IBM Systems Journal, Vol. 43, No. 1, 2004.

Reference with regard to a quality-of-service (QoS) assured composeable service infrastructure (QUEST) and management of QoS provisioning for composed services (e.g., based on the SLA contracts of individual services) may be made to Gu et al., “QoS-Assured Service Composition in Managed Service Overlay Networks,”Proceedings of the 23rd International Conference on Distributed Computing Systems (ICDCS'03) 2003.

The exemplary embodiments of the invention provide methods, computer program products and apparatus that describe techniques for improved selection of agreements between entities, such as between a service provider and another entity (e.g., a supplier or customer of the service provider).

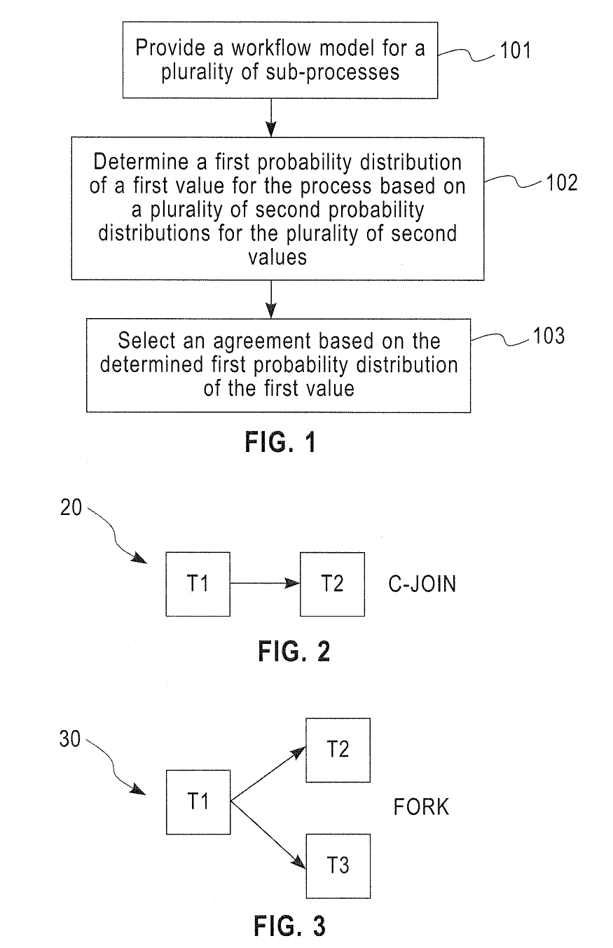

In one non-limiting, exemplary embodiment, and as shown in FIG. 1, a method includes the following steps. Provide a workflow model for a plurality of sub-processes (box 101). The plurality of sub-processes comprises a plurality of second values. Each sub-process of the plurality of sub-processes comprises a different second value of the plurality of second values corresponding to a property common to each sub-process of the plurality of sub-processes. The workflow model comprises a workflow model of a process.

Determine a first probability distribution of a first value for the process based on a plurality of second probability distributions for the plurality of second values (box 102). Each second probability distribution of the plurality of second probability distributions is for a different second values of the plurality of second values.

Select an agreement based on the determined first probability distribution of the first value (box 103). The selected agreement comprises an agreement to be used between a first entity and a second entity.

As non-limiting examples, one or both of the first entity and the second entity may comprise a supplier, a service provider and a customer. As non-limiting examples, the second value may comprise a downtime function or a representation of an amount of delay associated with the respective sub-process (e.g., a delay type function). As non-limiting examples, the agreement may comprise a service level agreement (SLA) and/or an operational level agreement (OLA).

In other exemplary embodiments, the method may further comprise: determining the plurality of second probability distributions based on the plurality of second values. In further exemplary embodiments, the method may further comprise: generating the workflow model. In other exemplary embodiments, the method further comprises: determining the plurality of second probability distributions based on the plurality of second values.

Cost effective, competitive IT service management is generally a challenging task. In order to be successful, an IT service provider may have to: design a service management architecture that satisfies their operational model, design appropriate service management processes, identify suppliers and other stakeholders and functional components that allow them to interact, define management interfaces for external access, model management information at different levels and establish shared knowledge resources that achieve security by employing authentication and access control.

A service management architecture that ensures efficient interactions between different stakeholders may be essential for a service provider. Below are considered three different operational models that allow a service provider to manage and control all or part of the offered services for multiple customers. A modeling approach is often used to structure the management functionality in an architectural framework in order that: control and management functions can be distributed between different stakeholders, the management services available at each interface in the architecture can be designated and the management information model for each stakeholder can be specified.

In a first model, a service provider fully manages all services for multiple customers. To perform this cost efficiently, the service provider may use shared resources and employ a solution that takes into account the various challenges inherent in multi-customer support. It may be desirable to separate customer-specific data, infrastructure, and shared infrastructure. In order to sustain services in this model, the supporting personnel could be structured in a number of different ways. For example, all of the service provider's employees could support all of the infrastructure based on their skills and qualifications. Alternatively, there could be restrictions, for example, based on customer sensitive data, which would limit the assignment of personnel to customer-specific resources. Such additional assignment of people/groups to the customer's resources or some subset thereof should also be optionally available in the service management solution for the service provider.

In a second model, customers may not only make requests and demands concerning the delivery and the use of services, but also on the facilities that are available for monitoring and controlling the services they buy. In the competitive environment that exists today, customer requirements concerning the control that they have over managed services may influence their purchasing decision. A basic customer requirement is access to information on status, fault, and statistics for the services. Thus, it may be desirable for service management systems employed by service providers to be able to provide secure access to such information for their customers. Customers may have access only to their own data and services for monitoring purposes, while the service provider has full control of all customers' services. Thus, the requirements for a service management solution for this model include data access, notification and monitoring for both the customers and the service provider and operations control for only the service provider.

In a third model, multiple supporting organizations participate in the service management. This may be suitable for large-scale service providers that are well-equipped to manage immense service systems for multiple enterprise customers. The service provider in this case has overall control over the infrastructure and manages some services itself. The customer actively participates in the overall process by providing some services and participating in monitoring and control. Some of the services can be provided by other, external suppliers. It may be necessary to include the suppliers' participation in the overall service management in order to support the unique business needs of some customers based on their diverse businesses.

One non-limiting, exemplary workflow model is described below. The described workflow model comprises a workflow model of a process having a plurality of sub-processes, referred to below as “tasks.” Each of the n tasks is denoted by T1, . . . , Tn.

For simplicity, the below-described tasks each have up to two inputs and up to two outputs. In other exemplary embodiments, a task may have more than two inputs and/or more than two outputs. Furthermore, in further exemplary embodiments, the workflow model may not comprise a linear arrangement of tasks. For example, the workflow model may be recursive (e.g., iterative) or cyclical.

FIG. 2 depicts an exemplary model 20 of two consecutive tasks, T1 and T2. As shown in FIG. 2, the tasks are executed sequentially, with the first task (T1) ending before the second task (T2) begins. For convenience, two consecutive tasks will be referred to as a “C-join.”

For convenience, any task whose completion may be required for another task to begin is referred to as a “previous task.” Any task whose beginning is conditioned on the completion of a previous task is referred to as a “subsequent task.” Thus, in FIG. 2, task T1 is a previous task and task T2 is a subsequent task.

FIG. 3 illustrates an exemplary model 30 of three tasks, T1, T2 and T3. The model 30 shows a “fork.” That is, once task T1 ends, tasks T2 and T3 simultaneously or substantially simultaneously begin.

In more complex models, such as ones having a number of stages and/or interrelated tasks, a task may be considered “previous” or “subsequent” only in relation to another task. For example, in FIG. 2, with respect to task T2, task T1 is a previous task. Similarly, with respect to task T1, task T2 is a subsequent task. Note also that with respect to task T1, task T3 is also a subsequent task.

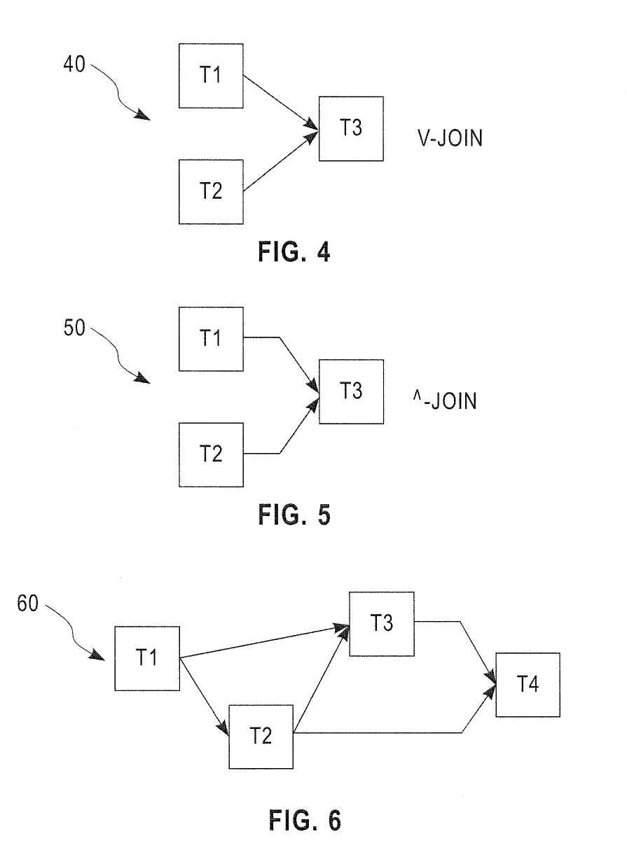

FIG. 4 depicts another exemplary model 40 of three tasks, T1, T2 and T3. The model 40 shows a first type of join, referred to herein as a “V-join.” For a V-join, upon completion of any of the previous tasks, the subsequent task begins. In FIG. 4, once either task T1 or task T2 finishes, task T3 begins.

Note that the above-noted previous/subsequent terminology is permissive and not limiting. For example, in the V-join depicted in FIG. 4, task T3 begins once either task T1 or task T2 is completed. Thus, task T1 may finish prior to task T2 and enable task T3 to begin. In such an example, although task T2 did not trigger the start of task T3, and thus the completion of task T2 bore no direct relation to the beginning of task T3, task T2 is still considered to be a previous task with respect to task T3 since, prior to the ending of task T1, the completion of task T2 would have triggered the beginning of task T3.

FIG. 5 illustrates another exemplary model 50 of three tasks, T1, T2 and T3. The model 50 shows a second type of join, referred to herein as a “̂-join.” For a ̂-join, in order for a subsequent task to begin, all of its related previous tasks must complete. Thus, in FIG. 5, task T3 may begin once task T1 and task T2 are completed.

It is briefly noted that the V-join corresponds to the Boolean logic operator [symbol] (logical OR) and that the ̂-join corresponds to the Boolean logic operator [symbol] (logical AND). Thus, the described model may be seen to present a Boolean arrangement of task operations where the execution of one or more tasks may be predicated on the completion of one or more other tasks.

As utilized herein, a “simple business process” is considered to be a connected model or network of tasks having one end point, where the model or network can be described by a directed acyclic graph (DAG). In other exemplary embodiments, the model may not comprise a simple business process and may include conditions or loops, as non-limiting examples.

Assume that each task Ti has a non-negative random variable associated with it describing the possible downtime DTi of the task Ti. It may be convenient to consider the downtime function to be piece-wise constant. Assume this for the below-described example wherein the downtime for an exemplary simple business process is calculated.

With respect to the four interactions depicted above in FIGS. 2-5, the following statements are taken to be the rules governing the calculation of downtime:

(a) For consecutive tasks T1 and T2 (e.g., model 20 in FIG. 2), the total downtime DTTot is a sum of the downtimes (e.g., downtime functions) of the consecutive tasks. That is:

DTTot=DT1+DT2 (1)

(b) For each branch of a fork (e.g., model 30 in FIG. 3), the total downtime DTTot is a sum of the downtimes (e.g., downtime functions) for the respective consecutive tasks. That is:

DTTot=DT1+DT2 (2)

DTTot′=DT1+DT3 (3)

(c) For a V-join (e.g., model 40 in FIG. 4), the total downtime DTTot is a sum of the downtimes for the least (i.e., minimum) of the previous tasks and the subsequent task. That is:

DTTot=min {DT1,DT2}+DT3 (4)

(d) For a ̂-join (e.g., model 50 in FIG. 5), the total downtime DTTot is a sum of the downtimes for the greatest (i.e., maximum) of the previous tasks and the subsequent task. That is:

DTTot=max {DT1,DT2}+DT3 (5)

Next, an iterative formula is provided for calculating the downtime function of a simple business process. Since a simple business process can be modeled as a DAG, one can consider a distance d(T) from the end point (i.e., from the end to the beginning of the modeled process) as a maximal number of consecutive tasks that need to be performed in order to proceed from the start task(s) to the end task. This distance may be calculated as:

d(T)=max_{{S|input (S)=output (T)}}d(S)+1 (6)

where S stands for a previous task to a task T. Note that the function described by equation (6) is correctly defined since the simple business process can be modeled as a DAG.

For each task Ti, denote a combined downtime function (CDF) DTi^{d(Ti)} of a simple business process having task Ti as the end task. The following relation is thus valid:

DTi^{d(Ti)}=M(DTj₁^{d(Tj}₁⁾,DTj₂^{d(Ti}₂⁾)+DTi, (7)

where distance functions for Ti, Tj₁ and Tj₂ are d(Ti), d(Tj₁) and d(Tj₂), respectively, and M stands for the function min for a V-join, the function max for a ̂-join and the function sum for a C-join. Due to the choice of the distance function, the following two inequalities thus hold:

d(Ti)<d(Tj₁) (8)

d(Ti)<d(Tj₂) (9)

Thus, the CDF (equation (7)) for a node can be expressed utilizing CDFs for previous nodes. In such a manner, the CDF for the end task DTn^{d(Tn)} of a simple business process may be calculated using an iterative substitute procedure as described herein utilizing equations (1) -(6). This iterative substitute procedure or use thereof may also be referred to as a “reduction process” or as “applying reductions.”

Consider the exemplary model 60 of tasks T1, T2, T3 and T4 shown in FIG. 6. The CDF of the end node, task T4, may be calculated as follows. First, the CDFs for any intermediate nodes (i.e., nodes previous to the end node but subsequent to another node) are determined. Note that, depending on the model, it may be necessary to determine (e.g., calculate) the CDFs of the intermediate nodes in a certain order. For example, since task T2 is previous to task T3, the CDF of task T2 should be determined before the CDF of task T3. Based on the model 60 of FIG. 6, the CDFs of tasks T2 and T3 can be represented as:

DT2^{d(T2)}=DT1+DT2 (10)

DT3^{d(T3)}=min {DT1^{d(T1)},DT2^{d(T2)}}+DT3 (11)

DT3^{d(T3)}=min {DT1,DT1+DT2}+DT3 (12)

Note that the “min” in equation (11) comes from the fact that the input to task T3 is a V-join.

Because the downtime functions for all nodes are assumed to be non-negative, equation (12) can be reduced further since the minimum of DT1 and DT1+DT2 will necessarily be DT1. Thus:

DT3^{d(T3)}=DT1+DT3 (13)

In such a manner, one now has the CDFs for the intermediate nodes. Next, one can calculate the CDF of the end node based on the CDFs of the nodes previous to the end node. In the model 60 of FIG. 6, tasks T2 and T3 are previous to the end node, task T4. Furthermore, the input to task T4 is a ̂-join. Thus, the CDF of the end node, task T4, can be calculated as:

DT4^{d(T4)}=max {DT2^{d(T2)},DT3^{d(T3)}}+DT4 (14)

Similar to equation (11), note that the “max” in equation (14) comes from the fact that the input to task T4 is a ̂-join. Substituting in equations (10) and (13), one has:

DT4^{d(T4)}=max {DT1+DT2,DT1+DT3}+DT4 (15)

Based on equation (15), one could also express the CDF of task T4 as:

$$DT {4}^{d ( T 4 )} = \{ \begin{matrix}DT 1 + DT 2 + DT 4 & if DT 2 \geq DT 3 \\ DT 1 + DT 3 + DT 4 & if DT 2 < DT 3\end{matrix} \qquad ( 16 )$$

Note that the reduction from equation (15) to equation (16) assumes that DT2 and DT3 are each independent from DT1.

Although the calculation of the CDF for the model 60 of FIG. 6 was relatively straight forward, practical calculation of the CDF may not be as simple for other models, even for mutually independent tasks, since possible joins can make various constituent CDFs, or the end task CDF, interdependent. In such cases, one may be able to use simulation capabilities of programs or applications in order to calculate the CDF of a simple business process. Exemplary programs having such capabilities include IBM WebSphere® Business Modeler products.

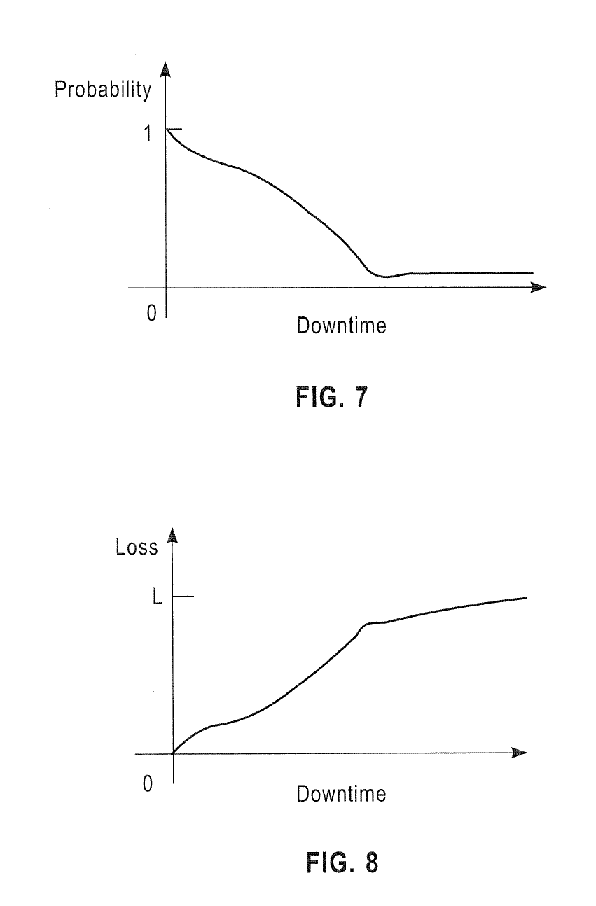

FIG. 7 shows a graph of an exemplary downtime function for a task. The probability of downtime (y-axis) is presented as a function of an amount of downtime α-axis).

A SLA function for a task Ti is a function SLi that maps downtime of the task Ti to the loss L associated for that task. It may be desirable to choose SLi as a piece-wise constant function.

FIG. 8 shows a graph of an exemplary SLA function (SLi) for a task Ti mapping downtime of the task Ti to the associated loss L. Generally, the expected loss for downtime of the function Ti may be considered as a value ∫SLi(DTi) dP, where P corresponds to a combined probability and expected loss is an average loss that may occur.

Consider the following. Assume that one has a simple business process where at least one of the tasks is performed by one or more suppliers. Furthermore, assume that interaction with a supplier executing a task Ti is regulated by a SLA function SLi and that one knows (e.g., has been provided or has determined) the combined SLA function SLn for the end task of the business process.

It may be desirable to check that:

(a) On average, a loss is not incurred due to external downtime (mean majorating SLA).

(b) A loss is not incurred in any possible case (absolute majorating SLA).

Start with embedding the simple business process into a probability space (Ω′, Σ′, P′), where relationships between sets defined by the random variables (downtime functions, SL functions) hold. The probability space exists due to the Kolmogorov Theorem. Next, extend the SLi function to a function SLi′ such that SLi′ is constant for all points in Ω′ that project into the same point on (Ωᵢ, Σᵢ, Pᵢ). This is possible because each Pᵢ is a probability measure. Now perform a similar procedure with the function SLn to obtain a function SLn′. If the mean of the combined SLA in the end task of the simple business process is not less than the mean of the SLi′, then SLn is an average majorating SLA. If SLn′ majorates SLi′ pointwise, then SLn′ is an absolute majorating SLA.

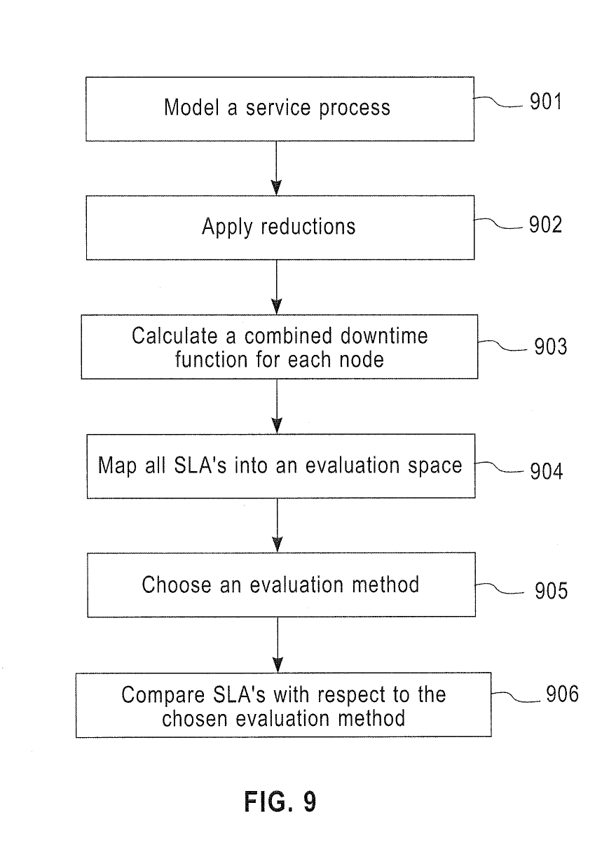

In one non-limiting, exemplary embodiment, and as shown in FIG. 9, a method for evaluating the effectiveness of SLAs includes the following steps. Model a service process (box 901). Apply reductions (box 902). Calculate a combined downtime function for each node in the model (box 903). Map the SLAs into an evaluation space (box 904). Choose an evaluation method (box 905). Compare SLAs with respect to the chosen evaluation method (box 906).

As non-limiting examples of suitable evaluation methods, and with respect to the three models identified above, consider the following examples. For the first model, a downtime function may be used to formulate an appropriate combined SLA for the service provider. For the second model, a combined SLA may be constructed that satisfies either the mean majorant condition or the absolute majorant condition over the suppliers. For the third model, where a customer may also be a supplier, it may be desirable to ensure that the SLA of the customer acting as a customer satisfies either the mean majorant condition or the absolute majorant condition with respect to the SLA of the customer acting as a supplier.

While described above with respect to a downtime function, the exemplary embodiments of the invention may be used in conjunction with other qualities and/or characteristics of processes and sub-processes, such as a delay type function, as a non-limiting example.

In another non-limiting, exemplary embodiment, a method includes: obtaining a plurality of sub-processes involved in a process, wherein the plurality of sub-processes comprises a plurality of second values, wherein each sub-process of the plurality of sub-processes comprises a different second value of the plurality of second values corresponding to a property common to each sub-process of the plurality of sub-processes; obtaining a workflow topology of the process; obtaining a plurality of second probability distributions for the plurality of second values, wherein each second probability distribution of the plurality of second probability distributions is for a different second value of the plurality of second values; determining a first probability distribution of a first value for the process based on the plurality of second probability distributions for the plurality of second values; and selecting an agreement based on the determined first probability distribution of the first value, wherein the selected agreement comprises an agreement to be used between a first entity and a second entity.

FIG. 11 illustrates a simplified block diagram of an electronic device 210 that is suitable for use in practicing the exemplary embodiments of this invention. The electronic device 210 includes a data processor (DP) 212 coupled to a memory (MEM) 214 and a database (DB) 216 coupled to the DP 212. The DB 216 stores a plurality of agreements (e.g., SLAs, OLAs). The DP 212 is configured to receive data 218. The DP 212 performs various operations on the data 218 and, based on the results of the operations, selects an agreement from DB 216 to be used between a first entity and a second entity. The DP 212 is further configured to output an identification (SEL) 220 of the selected agreement. As non-limiting examples, the SEL 220 may be output to a display device (e.g., a monitor), a printing device (e.g., a printer) or another electronic device (e.g., a computer).

In one exemplary embodiment, the data comprises a workflow model for a plurality of sub-processes. Each sub-process of the plurality of sub-processes comprises a certain value corresponding to a property common to each sub-process. The workflow model comprises a workflow model of a process. The DP 212 determines a first probability distribution of the process based on a plurality of second probability distributions. Each second probability distribution of the plurality of second probability distributions corresponds to a different sub-process of the plurality of sub-processes. The second probability distribution of a given sub-process is based on the corresponding certain value of the given sub-process. Based on the determined first probability distribution, the DP 212 selects an agreement to be used between a first entity and a second entity.

In other exemplary embodiments, the DP 212 does not select an agreement. In further exemplary embodiments, the MEM 214 may store the information (the plurality of agreements) stored in the DB 216. In other exemplary embodiments, the electronic device 210 comprises a communication component and is coupled to a network. In further exemplary embodiments, the DP 212 receives updates via the network.

In other exemplary embodiments, the processing unit is further configured to determine the plurality of second probability distributions based on the corresponding certain value of each of the plurality of sub-processes. In further exemplary embodiments, the processing unit is further configured to generate the workflow model. In other exemplary embodiments, the agreement comprises at least one of a service level agreement or an operational level agreement. In further exemplary embodiments, the first entity comprises a service provider and the second entity comprises at least one of a supplier or a customer. In further exemplary embodiments, the certain value comprises at least one of a downtime function and a delay type function.

The exemplary embodiments of this invention may be carried out by computer software implemented by the DP 212 or by hardware, or by a combination of hardware and software. As a non-limiting example, the exemplary embodiments of this invention may be implemented by one or more integrated circuits. The MEM 214 may be of any type appropriate to the technical environment and may be implemented using any appropriate data storage technology, such as optical memory devices, magnetic memory devices, semiconductor-based memory devices, fixed memory and removable memory, as non-limiting examples. The DP 212 may be of any type appropriate to the technical environment, and may encompass one or more of microprocessors, general purpose computers, special purpose computers and processors based on a multi-core architecture, as non-limiting examples.

Exemplary embodiments of the invention can take the form of an entirely hardware embodiment, an entirely software embodiment or an embodiment containing both hardware and software elements. In a typical embodiment, the invention is implemented in software, which includes but is not limited to firmware, resident software and/or microcode, as non-limiting examples. Generally, various exemplary embodiments of the invention can be implemented in different mediums, such as software, hardware, logic, special purpose circuits or any combination thereof. As a non-limiting example, some aspects may be implemented in software which may be run on a computing device, while other aspects may be implemented in hardware.

Furthermore, exemplary embodiments of the invention can take the form of a computer program product accessible from a computer-useable or computer-readable medium providing program code for use by or in connection with a computer or any instruction execution system. For the purposes of this description, a computer-useable or computer-readable medium can be any apparatus that can contain, store, communicate, propagate, or transport the program for use by or in connection with the instruction execution system, apparatus, or device.

The medium can be electronic, magnetic, optical, electromagnetic, infrared, a semiconductor system (or apparatus or device) or a propagation medium, as non-limiting examples. Non-limiting examples of a computer-readable medium include a semiconductor or solid state memory, magnetic tape, a removable computer diskette, a random access memory (RAM), a read-only memory (ROM), a rigid magnetic disk and an optical disk. Current, non-limiting examples of optical disks include compact disk-read only memory (CR-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or indirectly through intervening I/O controllers.

Network adapters may also be coupled to the system to enable the data processing system to become coupled to other data processing systems or remote printers or storage devices through intervening private or public networks. Modems, cable modem and Ethernet cards are just a few non-limiting examples of the currently available types of network adapters.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
providing a workflow model for a plurality of sub-processes, wherein the plurality of sub-processes comprises a plurality of second values, wherein each sub-process of the plurality of sub-processes comprises a different second value of the plurality of second values corresponding to a property common to each sub-process of the plurality of sub-processes, wherein the workflow model comprises a workflow model of a process;
determining a first probability distribution of a first value for the process based on a plurality of second probability distributions for the plurality of second values, wherein each second probability distribution of the plurality of second probability distributions is for a different second value of the plurality of second values; and
selecting an agreement based on the determined first probability distribution of the first value, wherein the selected agreement comprises an agreement to be used between a first entity and a second entity.

2. The method of claim 1, further comprising:
determining the plurality of second probability distributions based on the plurality of second values.

3. The method of claim 1, further comprising:
generating the workflow model.

4. The method of claim 1, wherein the agreement comprises at least one of a service level agreement or an operational level agreement.

5. The method of claim 1, wherein the first entity comprises a service provider and the second entity comprises at least one of a supplier or a customer.

6. The method of claim 1, wherein the second value comprises at least one of a downtime function and a delay type function.

7. A computer program product comprising program instructions embodied on a tangible computer-readable medium, execution of the program instructions resulting in operations comprising:
providing a workflow model for a plurality of sub-processes, wherein the plurality of sub-processes comprises a plurality of second values, wherein each sub-process of the plurality of sub-processes comprises a different second value of the plurality of second values corresponding to a property common to each sub-process of the plurality of sub-processes, wherein the workflow model comprises a workflow model of a process;
determining a first probability distribution of a first value for the process based on a plurality of second probability distributions for the plurality of second values, wherein each second probability distribution of the plurality of second probability distributions is for a different second value of the plurality of second values; and
selecting an agreement based on the determined first probability distribution of the first value, wherein the selected agreement comprises an agreement to be used between a first entity and a second entity.

8. The computer program product of claim 7, wherein execution of the program instructions results in operations further comprising:
determining the plurality of second probability distributions based on the plurality of second values.

9. The computer program product of claim 7, wherein execution of the program instructions results in operations further comprising:
generating the workflow model.

10. The computer program product of claim 7, wherein the agreement comprises at least one of a service level agreement or an operational level agreement.

11. The computer program product of claim 7, wherein the first entity comprises a service provider and the second entity comprises at least one of a supplier or a customer.

12. The computer program product of claim 7, wherein the second value comprises at least one of a downtime function and a delay type function.

13. A processing device comprising:
an input configured to receive a workflow model for a plurality of sub-processes, wherein the plurality of sub-processes comprises a plurality of second values, wherein each sub-process of the plurality of sub-processes comprises a different second value of the plurality of second values corresponding to a property common to each sub-process of the plurality of sub-processes, wherein the workflow model comprises a workflow model of a process;
a processing unit coupled to the input and configured to determine a first probability distribution of a first value for the process based on a plurality of second probability distributions for the plurality of second values and to select an agreement based on the determined first probability distribution of the first value, wherein each second probability distribution of the plurality of second probability distributions is for a different second value of the plurality of second values, wherein the selected agreement comprises an agreement to be used between a first entity and a second entity; and
an output coupled to the processing unit and configured to output an identification of the selected agreement.

14. The processing device of claim 13, wherein the processing unit is further configured to determine the plurality of second probability distributions based on the plurality of second values.

15. The processing device of claim 13, wherein the processing unit is further configured to generate the workflow model.

16. The processing device of claim 13, wherein the agreement comprises at least one of a service level agreement or an operational level agreement.

17. The processing device of claim 13, wherein the first entity comprises a service provider and the second entity comprises at least one of a supplier or a customer.

18. A method comprising:
obtaining a plurality of sub-processes involved in a process, wherein the plurality of sub-processes comprises a plurality of second values, wherein each sub-process of the plurality of sub-processes comprises a different second value of the plurality of second values corresponding to a property common to each sub-process of the plurality of sub-processes;
obtaining a workflow topology of the process;
obtaining a plurality of second probability distributions for the plurality of second values, wherein each second probability distribution of the plurality of second probability distributions is for a different second value of the plurality of second values;
determining a first probability distribution of a first value for the process based on the plurality of second probability distributions for the plurality of second values; and
selecting an agreement based on the determined first probability distribution of the first value, wherein the selected agreement comprises an agreement to be used between a first entity and a second entity.

19. The method of claim 18, wherein the agreement comprises at least one of a service level agreement or an operational level agreement.

20. The method of claim 18, wherein the first entity comprises a service provider and the second entity comprises at least one of a supplier or a customer.
